(19) United States
(12) Patent Application Publication
(10) Pub. No.: US 2011/0032554 A1
(43) Pub. Date: Feb. 10, 2011

(54) IMAGE PROCESSING APPARATUS

(75) Inventor: Masatoshi Matsuhira, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/852,386

(22) Filed: Aug. 6, 2010

(30) Foreign Application Priority Data
Aug. 7, 2009 (JP) 2009-184993

(51) Int. Cl. H04N 1/60

(52) U.S. Cl. 358/1.9

(57) ABSTRACT

An image processing apparatus which generates print data for driving a printing head having nozzle groups for color which are capable of discharging ink at a first resolution and nozzle groups for black which are capable of discharging ink at a second resolution which is higher than the first resolution includes a first processing device which inputs image data, and a second processing device which is communicably connected to the first processing device through a predetermined communication interface.

### BACKGROUND

1. Technical Field

The present invention relates to an image processing apparatus.

2. Related Art

As existing image processing apparatuses of this type, an image processing apparatus which separates a black character region and a picture region in a color image has been proposed (for example, see JP-A-2004-187119 or JP-A-05-48892). In the apparatus, a black character region in a color image is extracted and printing is performed on the extracted black character region with black only. Therefore, excellent black character quality can be obtained.

In such a manner, a character region and a picture region in a color image are previously separated and different printing processes are performed on each of the regions. Therefore, printing quality can be improved. However, since a processor having a relatively low processing capability is installed on the printing apparatus in many cases, much time is required for the process and a printing speed is reduced in some case.

### SUMMARY

An advantage of some aspects of the invention is to provide an image processing apparatus which prints a black character in a color image with high quality and improves an entire processing speed.

The image processing apparatus according to an aspect of the invention employs the following means in order to obtain the above advantage.

An image processing apparatus according to an aspect of the invention generates print data for driving a printing head having nozzle groups for color which are capable of discharging ink at a first resolution and nozzle groups for black which are capable of discharging ink at a second resolution which is higher than the first resolution. The image processing apparatus includes a first processing device which inputs image data, and a second processing device which is communicably connected to the first processing device through a predetermined communication interface. Further, in the image processing apparatus, the first processing device acquires a color image having the second resolution, extracts a black character region image from the acquired color image, transmits the extracted black character region image to the second processing device through the predetermined communication interface, and generates print data for driving the nozzle groups for color from a remaining not-black character region image accompanied with a resolution conversion to the first resolution, and the second processing device generates print data for driving the nozzle groups for black based on the black character region image transmitted from the first processing device.

In the image processing apparatus according to the aspect of the invention, the first processing device acquires a color image having the second resolution, extracts a black character region image from the acquired color image, transmits the extracted black character region image to the second processing device through the predetermined communication interface, and generates print data for driving the nozzle groups for color from a remaining not-black character region image accompanied with a resolution conversion to the first resolution, and the second processing device generates print data for driving the nozzle groups for black based on the black character region image received from the first processing device. With this configuration, a black character in a color image can be printed with high quality and reduction in an entire processing speed can be suppressed even when processing devices each of which processing speed is relatively low are used.

In the image processing apparatus according to the aspect of the invention, it is preferable that the first processing device acquire image data of an RGB color system having the second resolution as the color image, extract the black character region image from the acquired image data of the RGB color system and transmit the black character region image to the second processing device as K data of a CMYK color system, convert the resolution of the remaining not-black character region image to the first resolution, convert the color of the data after the resolution conversion to CMY data by using a three-dimensional look-up table, and generate print data for driving the nozzle groups for color by performing a binarization processing on the converted CMY data, and the second processing device generate print data for driving the nozzle groups for black by performing a binarization processing on K data received from the first processing device. With this configuration, since it is sufficient that the first processing device performs the color conversion processing by using the three-dimensional look-up table on RGB data having the first resolution lower than the second resolution. Therefore, a processing quantity can be reduced and an entire processing speed can be further improved. In the image processing apparatus according to the aspect of the invention, it is preferable that the second processing device generate the print data by subjecting K data received from the first processing device to a color adjustment by using a one-dimensional look-up table and binarizing the K data which has been subjected to the color adjustment. Accordingly, print quality of the black character in a color image can be further improved.

In the image processing apparatus according to the aspect of the invention, it is preferable that the first processing device compress the extracted black character region image by performing a predetermined compression processing and transmit the compressed image to the second processing device, and the second processing device decompress the received compressed image and generate the print data by using K data obtained by the decompression. With this configuration, an amount of data required for transferring to the second processing device can be made small. Therefore, reduction in the entire processing speed due to the data transfer processing can be prevented. In this case, the predetermined compression processing may be a lossless compression processing.

### BRIEF DESCRIPTION OF THE DRAWINGS

The invention will be described with reference to the accompanying drawings, wherein like numbers reference like elements.

FIG. 1 is a diagram illustrating a schematic configuration of an ink jet printer.

FIG. 2 is a diagram illustrating a schematic configuration of a printing head.

FIG. 3 is a descriptive diagram illustrating an electric connection relationship between ASICs and the printing head.

FIGS. 4A and 4B are functional block diagrams illustrating the ASICs.

FIG. 5 is a descriptive flowchart illustrating a sequence of a printing process.

### DESCRIPTION OF EXEMPLARY EMBODIMENTS

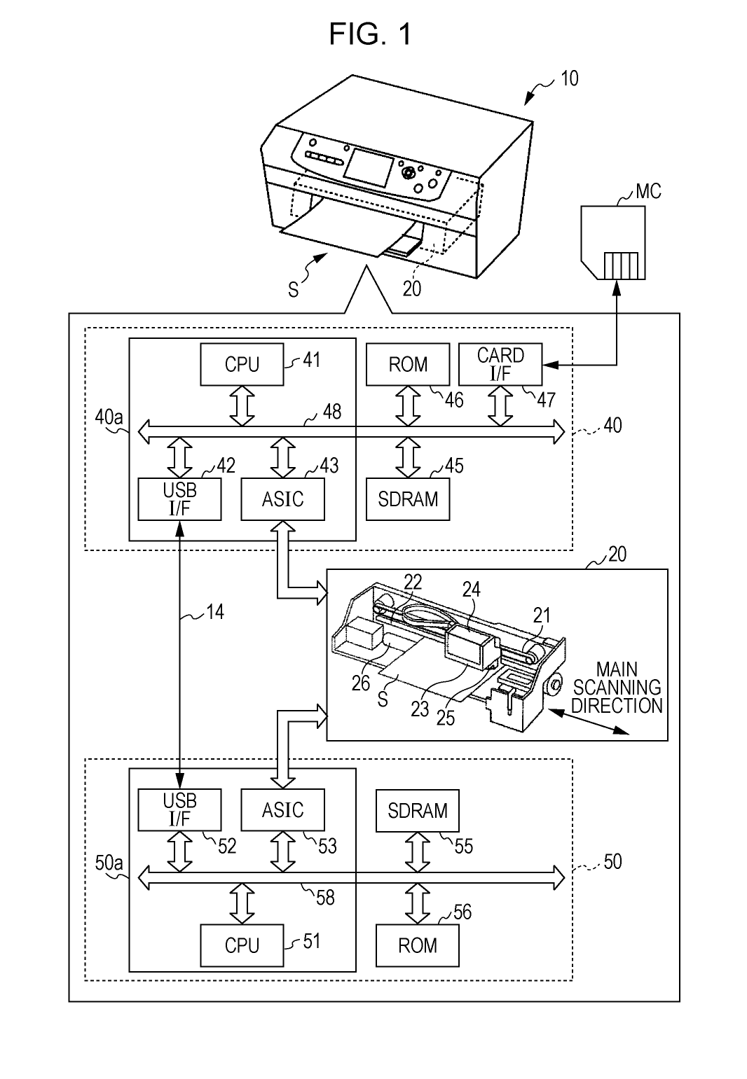

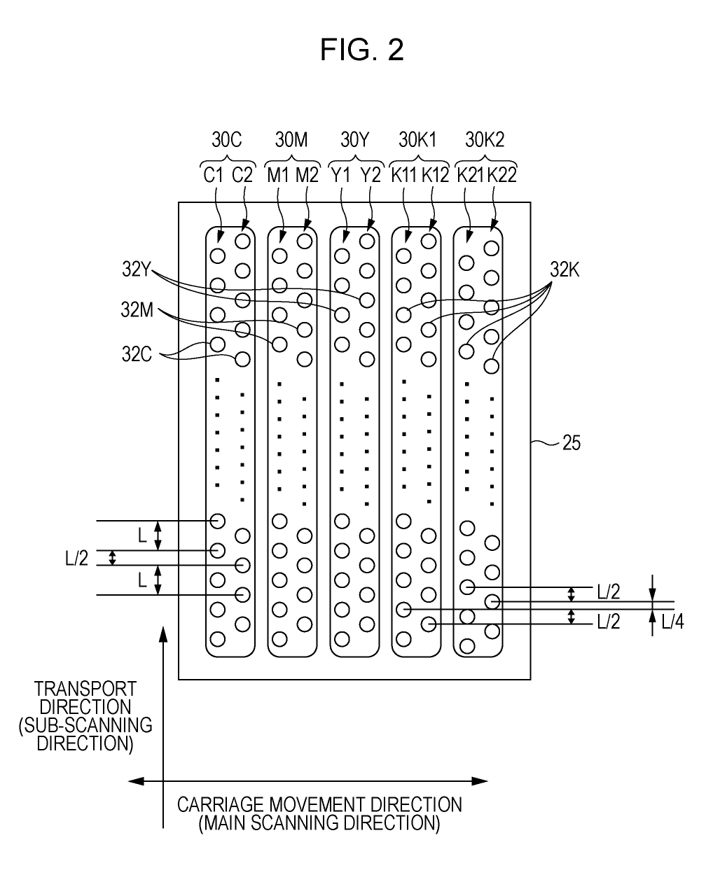

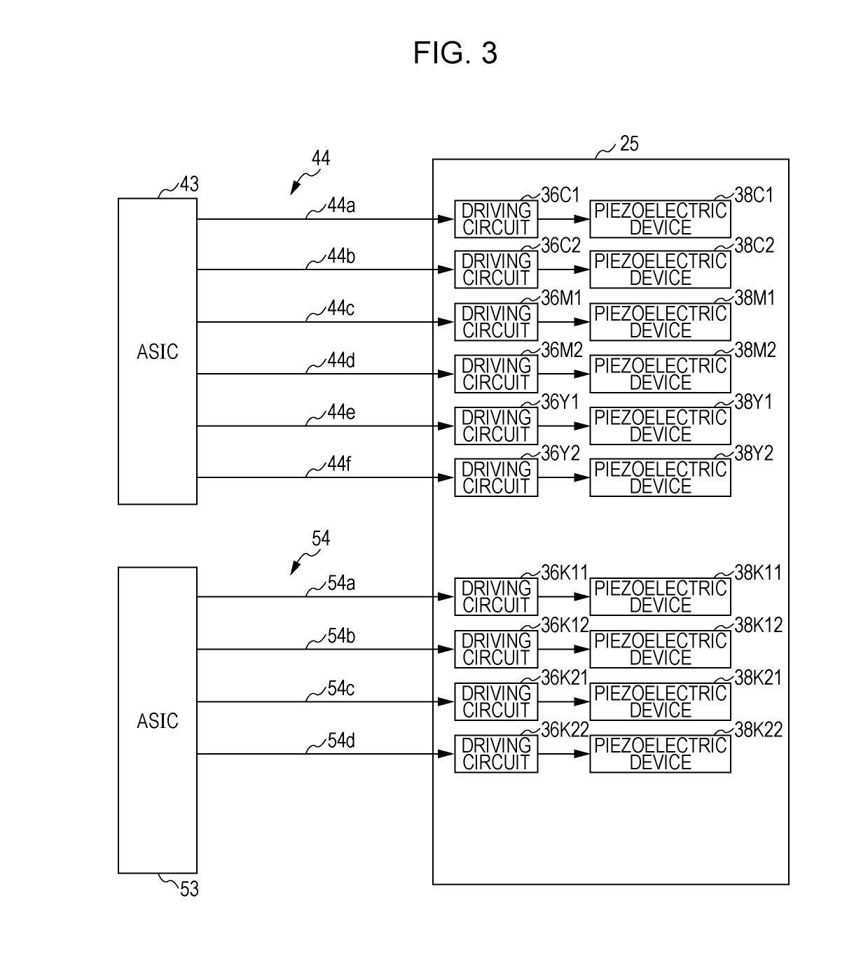

Hereinafter, an embodiment of the invention will be described with reference to drawings. FIG. 1 is a diagram illustrating a schematic configuration of an ink jet printer 10 on which an image processing apparatus according to the invention is installed. FIG. 2 is a diagram illustrating a schematic configuration of a printing head 25. FIG. 3 is a descriptive diagram illustrating an electric connection relationship between ASICs 43, 53 and the printing head 25. As shown in FIG. 1, the ink jet printer 10 according to the embodiment includes a printer mechanism 20, a main controller 40 and a sub controller 50. The printer mechanism 20 prints an image onto a recording sheet S. The main controller 40 executes various types of processings. The sub controller 50 is connected to the main controller 40 through a USB cable 14 so as to communicate and executes various types of processings. Here, the image processing apparatus corresponds to the main controller 40 and the sub controller 50.

The printer mechanism 20 includes a carriage 23, ink cartridges 24, a printing head 25 and a transportation roller 26. The carriage 23 is driven by a belt 21 bridged in a loop form in the horizontal direction to reciprocate in the horizontal direction (main scanning direction) along a guide 22. The ink cartridges 24 are installed on the carriage 23 and individually accommodate each color ink of cyan (C), magenta (M), yellow (Y), and black (K) (hereinafter, appropriately referred to as C, M, Y, K). The printing head 25 discharges ink onto the recording sheet S by applying a pressure to each ink supplied from each ink cartridge 24. The transport roller 26 feeds the recording sheet S supplied from a rear face side to a front side. As shown in FIG. 2, nozzle groups 30C, 30M, 30Y and nozzle groups 30K1, 30K2 are formed on the printing head 25. In the nozzle groups 30C, 30M, 30Y, nozzles 32C, 32M, 32Y which are capable of individually discharging each color ink of CMY are arranged along the transport direction (sub-scanning direction) of the recording sheet S. In the nozzle groups 30K1, 30K2, nozzles 32K which are capable of discharging ink of black (K) are arranged along the sub-scanning direction. A configuration of each nozzle group is described by taking the nozzle group 30C for cyan (C) as an example. The nozzle group 30C is formed of two nozzle rows C1, C2 and nozzles 32C are arranged such that a nozzle pitch is a predetermined length L in each of the nozzle rows C1, C2. Further, the nozzles 32c in the nozzle row C1 and the nozzles 32C in the nozzle row C2 are arranged in a zigzag form along the sub-scanning direction. Further, a nozzle pitch between the nozzles 32C in the nozzle row C1 and the nozzles 32C in the nozzle row C2 is L/2, which is half of the predetermined length L. In the embodiment, the predetermined length L is set such that a resolution of dots is 150 dpi. Further, the resolution of dots of cyan (C) becomes 300 dpi by performing printing such that dots formed by the nozzle row C1 and dots formed by the nozzle row C2 are alternatively arranged in a row in the sub-scanning direction. The nozzle group 30M for magenta (M) and the nozzle group 30Y for yellow (Y) have the same configuration as the nozzle group 30C so that the obtained resolutions thereof are 300 dpi. In addition, the nozzle groups 30K1, 30K2 for black (K) are formed of two nozzle rows K11, K12 and two nozzle rows K21, K22, respectively. Further, the nozzle groups 30K1, 30K2 for black (K) are arranged such that the nozzle pitch between the nozzles 32K in the nozzle group 30K1 and the nozzles 32K in the nozzle group 30K2 in the sub-scanning direction is length L/4, which is half of the length L/2. Therefore, the resolution of dots of black (K) becomes 600 dpi by performing printing such that dots formed by the nozzle group 30K1 and dots formed by the nozzle group 30K2 are alternatively arranged in a row in the sub-scanning direction. In such a manner, the printing head 25 includes 10 nozzle rows in total and is configured such that the resolutions of dots of CMY are 300 dpi and the resolution of dots of K is 600 dpi. That is to say, a nozzle density of the nozzles for K is higher than a nozzle density of the nozzles for CMY. The printing head 25 deforms piezoelectric devices by applying a voltage to the piezoelectric devices individually provided on each nozzle. Therefore, pressurized inks are discharged so as to form dots on the recording sheet S. In FIG. 3, the piezoelectric devices provided on each of the nozzles 32C in the nozzle row C1 are collectively illustrated as a piezoelectric device 38C1. The printing head 25 includes a driving circuit 36C1 as a circuit which applies a voltage to the piezoelectric device 38C1. In the same manner, piezoelectric devices provided on each of the nozzles in the nozzle rows C2 to K22 are collectively illustrated as piezoelectric devices 38C2 to 38K22, respectively. Further, the printing head 25 includes driving circuits 36C2 to 36K22 as circuits which apply voltage to these piezoelectric devices 38C2 to 38K22, respectively. Note that since the printing head 25 includes 10 nozzle rows in total, the printing head 25 includes 10 driving circuits 36C1 to 36K22 in total.

As shown in FIG. 1, the main controller 40 includes a System On a Chip (SOC) 40a, a ROM 46, an SDRAM 45, and a card interface (I/F) 47. A CPU 41 and the like are installed on the SOC 40a. The ROM 46 stores various types of data and various types of tables. Data can be read from and written into the SDRAM 45. The card interface (I/F) 47 is used for connecting to the main controller 40 a memory card MC in which image data such as a photograph is stored. A USB interface (I/F) 42, an ASIC 43, an SRAM (not shown) and the like are installed on the SOC 40a in addition to the CPU 41. The USB I/F 42 exchanges information with the sub controller 50. The ASIC 43 executes various types of processings relating to a printing process and controls the printer mechanism 20. The SRAM can be accessed at a speed higher than the SDRAM 45. These components installed on the SOC 40a are connected to each other through a bus 48 so as to exchange various types of control signals and data with each other. The bus 48 functions as an external bus which connects the SOC 40a with the ROM 46, the SDRAM 45 and the card I/F 47. As shown in FIG. 3, the ASIC 43 connects to each of six driving circuits 36C1 to 36Y2 through six transmission cables 44 (44a to 44f) so as to transmit a driving signal to each of the driving circuits 36C1 to 36Y2. Each of the six driving circuits 36C1 to 36Y2 drives each of the nozzle groups 30C, 30M, 30Y for CMY in the printing head 25. Accordingly, the main controller 40 can drive the nozzle groups 30C, 30M, 30Y for CMY among the nozzle groups 30C, 30M, 30Y, 30K1, 30K2 of the printing head 25. Further, the main controller 40 inputs various types of operation signals from the printer mechanism 20, inputs various types of control signals transmitted from the sub controller 50 through the USB I/F 42, and inputs image data stored in the memory card MC through the card I/F 47. In addition, the main controller 40 outputs image data and various types of control signals to the sub controller 50 through the USB I/F 42. Image data input from the memory card MC through the card I/F 47 is stored in the SDRAM 45 as RGB data of 600 dpi in correspondence to the resolution of K dots in the printing head 25. When the input image data is data other than RGB data, the image data is stored after the color of the image data is converted to RGB data by the CPU 41. Further, when the resolution of the image data is not 600 dpi, pixels are generated between adjacent pixels by interpolation or pixels are thinned out at a predetermined rate. Note that each value of the RGB data is represented by 256 tones (8 bits) from 0 to 255 depending on the darkness thereof.

As shown in FIG. 1, the sub controller 50 includes an SOC 50a, a ROM 56 and an SDRAM 55. A CPU 51 and the like are installed on the SOC 50a. The ROM 56 stores various types of data and various types of tables. Data can be read from and written into the SDRAM 55. As in the main controller 40, a USB interface (I/F) 52, an ASIC 53, an SRAM (not shown), and the like are installed on the SOC 50a in addition to the CPU 51. The ASIC 53 executes various types of processings relating to a printing process and controls the printer mechanism 20. The SRAM can be accessed at a speed higher than the SDRAM 55. These components installed on the SOC 50a are connected to each other through a bus 58 so as to exchange various types of control signals and data with each other. The sub controller 50 inputs image data and various types of control signals transmitted from the main controller 40 through the USB I/F 52 and outputs various types of control signals to the main controller 40 through the USB I/F 52. Note that the input image data is stored in the SDRAM 55. As shown in FIG. 3, the ASIC 53 is connected to each of four driving circuits 36K11 to 36K22 through four transmission cables 54 (54a to 54d) so as to transmit a driving signal to each of the driving circuits 36K11 to 36K22. Each of the four driving circuits 36K11 to 36K22 drives each of the nozzle groups 30K1, 30K2 for K in the printing head 25. Accordingly, the sub controller 50 can drive the nozzle groups 30K1, 30K2 for K among the nozzle groups 30C, 30M, 30Y, 30K1, 30K2 of the printing head 25.

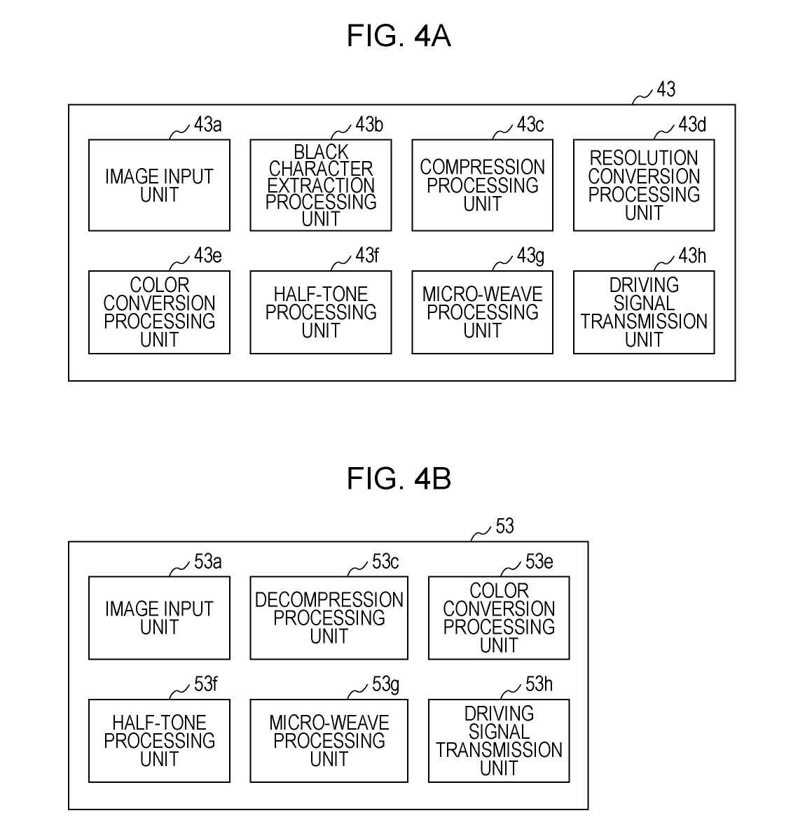

Hereinafter, each function of the ASIC 43 of the main controller 40 and the ASIC 53 of the sub controller 50 relating to the printing process is described. FIGS. 4A and 4B are functional block diagrams of the ASICs 43, 53. As shown in FIG. 4A, the ASIC 43 includes an image input unit 43a, a black character region extraction processing unit 43b, a compression processing unit 43c, a resolution conversion processing unit 43d, a color conversion processing unit 43e, a half-tone processing unit 43f, a micro-weave processing unit 43g, and a driving signal transmission unit 43h. The image input unit 43a inputs RGB data stored in the SDRAM 45 for only an amount of data required for a processing. For example, the image input unit 43a inputs RGB data for an amount of data required for a processing of generating print data for one pass of the printing head 25. The black character region extraction processing unit 43b is a processing unit for extracting a black character from the input RGB data. To be more specific, the black character region extraction processing unit 43b judges whether each tone value of a target pixel is equal to or greater than a predetermined threshold value and R=G=B is satisfied. If each tone value of the target pixel is equal to or greater than the predetermined threshold value and R=G=B is satisfied, pattern matching is performed by using 3×3 pixels of which center pixel is the target pixel. With the pattern matching, the black character region extraction processing unit 43b judges whether the target pixel is a pixel constituting a black character. The pixel constituting the black character, which has been extracted by the black character region extraction processing unit 43b, is taken out as K data. The compression processing unit 43c performs a compression processing on the K data taken out by the black character region extraction processing unit 43b. The compression processing is performed by a lossless compression system. In the embodiment, run-length encoding in which a sequence of the same data value is encoded and compressed is used. At this time, since ink of K is only used for printing relatively dark colors, a generation probability of K data is lower than that of CMY data in color printing in many cases. Therefore, when K data is extracted from CMYK data so as to perform the run-length encoding, blanks without K data are continuously formed in many cases, thereby smoothly performing the compression processing and improving a compression efficiency. The resolution conversion processing unit 43d converts resolution by thinning out pixels at a predetermined rate, calculating an average value of tone values of adjacent pixels to replace by one pixel, or generating new pixels between adjacent pixels by interpolation. The color conversion processing unit 43e performs a color conversion processing in which the input RGB data is converted to CMY data by referring to a three-dimensional color conversion look-up table (3D-LUT) stored in the SDRAM 45. Each value of the CMY data which has been subjected to the color conversion processing is represented by 256 tones (8 bits) from 0 to 255 depending on the darkness thereof. The half-tone processing unit 43f performs a half-tone processing in which CMYK data of 8 bits is converted to binarized data of 2 bits. The half-tone processing is performed by using a dithering method or an error diffusion method. The dithering method is a method in which dots are binarized to ON/OFF state by comparing a magnitude of a threshold value provided by a predetermined dither matrix and that of a tone value of each pixel. On the other hand, the error diffusion method is a method in which dots are binarized to ON/OFF state by comparing a magnitude of a predetermined threshold value and that of a tone value of a target pixel and an error, which is a difference between a tone value after the binarization and an original tone value, is diffused into unprocessed pixels peripheral to the target pixel at a specified rate. In such a manner, in the half-tone processing, a processing is required to be performed on each pixel of the CMYK data even when either processing is used. The micro-weave processing unit 43g generates image data for one pass by sorting the binarized data which has been subjected to the half-tone processing in the order that the printing head 25 forms dots. At this time, if the nozzle pitch is larger than a space corresponding to a printing resolution, the order of forming dots is determined such that a so-called micro-weave processing is performed. In the micro-weave processing, spaces in a dot line formed in the previous pass are filled with a dot line to be formed in the next pass. The driving signal transmission unit 43h generates a pulse of voltage to be applied to each of the piezoelectric devices 38C1 to 38K22 of the printing head 25 as a driving signal from image data for one pass. Then, the driving signal transmission unit 43h transmits the generated pulse to each of the driving circuits 36C1 to 36K22. These processing units perform their processings by storing the processed data in a data buffer (not shown) in the SDRAM 45, or reading out the data to be processed from the data buffer in the SDRAM 45. It is to be noted that although not shown, a motor for reciprocating the carriage 23 of the printer mechanism 20 and a motor for driving the transport roller 26 are controlled by the ASIC 43.

On the other hand, as shown in FIG. 4B, the ASIC 53 includes an image input unit 53a, a decompression processing unit 53c, a color conversion processing unit 53e, a half-tone processing unit 53f, a micro-weave processing unit 53g, and a driving signal transmission unit 53h. The image input unit 53a inputs image data stored in the SDRAM 55. The decompression processing unit 53c performs a decompression processing on image data which has been subjected to the compression processing by the run-length encoding. The color conversion processing unit 53e converts K data which has been subjected to the decompression processing to K data which is appropriate for printing by referring to a one-dimensional color conversion look-up table (1D-LUT). The half-tone processing unit 53f, the micro-weave processing unit 53g, and the driving signal transmission unit 53h perform the same processings as those performed by the half-tone processing unit 43f, the micro-weave processing unit 43g, and the driving signal transmission unit 43h of the ASIC 43. Note that each value of the K data which has been subjected to the color conversion processing by the color conversion processing unit 53e is represented by 256 tones (8 bits) from 0 to 255 depending on the concentration thereof. These processing units perform processings by using a data buffer (not shown) of the SDRAM 55 as in the processing units of the ASIC 43. Thus, each of the ASICs 43, 53 performs each processing by using each data buffer in each of the SDRAMs 45, 55. Therefore, the main controller 40 and the sub controller 50 can perform processings independent of each other.

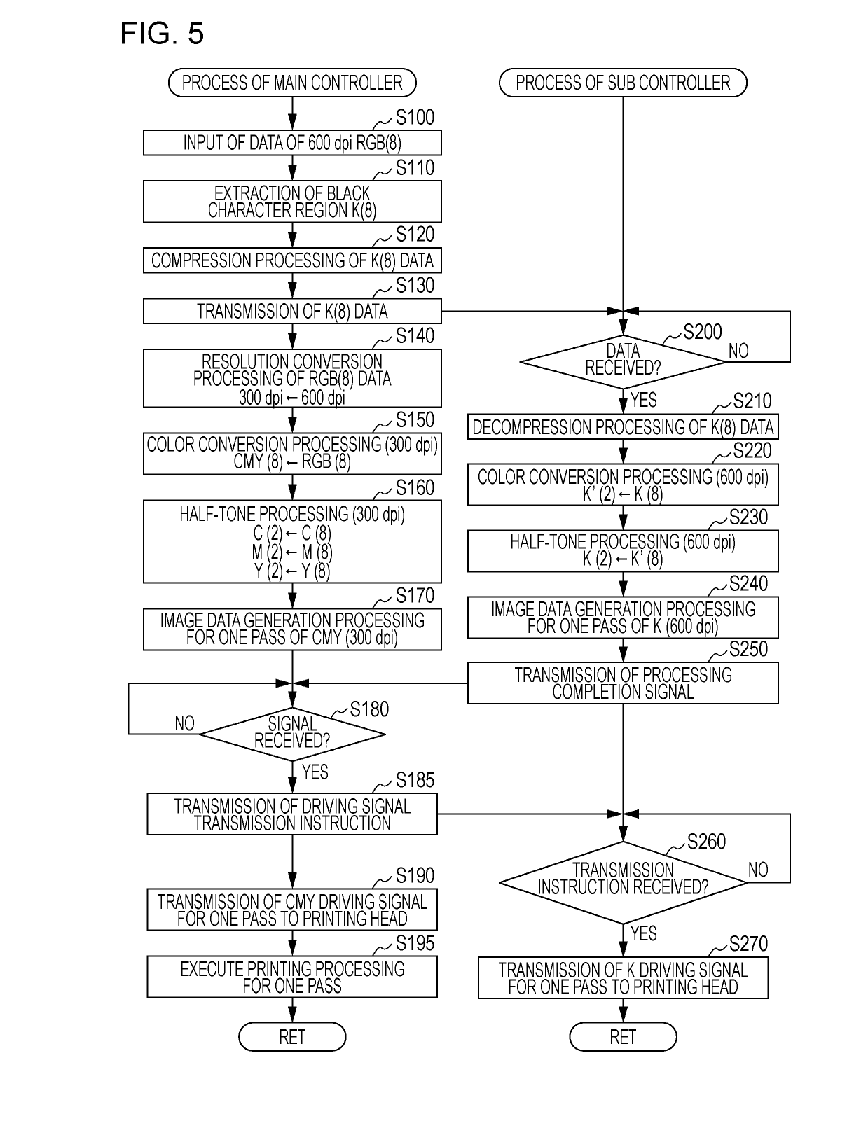

Next, an operation of the ink jet printer 10 configured as described above according to the embodiment, in particular, an operation when the printing process is performed based on 8-bit RGB data stored in the SDRAM 45 will be explained. At this time, the resolution of the 8-bit RGB data is 600 dpi. FIG. 5 is a descriptive flowchart illustrating a sequence when a printing process is executed by the main controller 40 and the sub controller 50. In the sequence, the main controller 40 executes the processings by appropriately using the above processing functions of the CPU 41 or the ASIC 43 and the same is true in the case of the sub controller 50. It is to be noted that numerical values in parentheses in FIG. 5 represent bit numbers of image data. At first, the main controller 40 inputs RGB data required for the printing process for one pass among RGB data stored in the SDRAM 45 (step S100 (hereinafter called as Sn, n=1, 2, 3 and so on)). Next, K data is taken out by executing the black character region extraction processing in which a black character region is extracted from the input RGB data of 8 bits (S110). Then, the K data which has been taken out is compressed (S120) so as to transmit the K data to the sub controller 50 (S130). As described above, since the K data can be effectively compressed by the run-length encoding, the compression processing can be smoothly performed so as to make data transmission time shorter. Further, since the run-length encoding is a lossless compression, image quality can be prevented from being deteriorated. Subsequently, the resolution conversion processing in which the resolution is converted from 600 dpi to 300 dpi is executed on remaining RGB data after the K data is taken out from the RGB data (S140). And the color conversion processing in which the color of the RGB data after resolution conversion is converted to CMY data of 8 bits by using the 3D-LUT is executed (S150). Since the color conversion processing is executed by using the 3D-LUT, the processing is relatively heavy. However, in the embodiment, after the K data is taken out at the required resolution of 600 dpi and the resolution of the remaining RGB data is converted from 600 dpi to 300 dpi, the color conversion processing is applied to the RGB data of which resolution has been converted. Therefore, the processing quantity can be largely reduced. After the color conversion processing is performed in such a manner, a half-tone processing in which CMY data of 8 bits is converted to binarized data of 2 bits is executed (S160), and image data of CMY for one pass is generated (S170). Then, the main controller 40 waits to receive a processing completion signal to be transmitted from the sub controller 50 (S180).

On the other hand, the sub controller 50 waits to receive K data to be transmitted from the main controller 40 (S200) and executes a decompression processing of the received K data (S210). After the decompression processing is executed, a color conversion processing in which the K data which has been subjected to the decompression processing is converted to K data which is appropriate for printing by referring to the 1D-LUT is executed (S220). Then, a half-tone processing in which the K data of 8 bits is converted to binarized data of 2 bits is executed (S230), and image data of K for one pass is generated (S240). It is to be noted that since the transmitted K data is 600 dpi in correspondence with the resolution of K, the resolution conversion processing is not performed in the sub controller 50. In the color conversion processing, the color of the K data of 600 dpi, which is a higher resolution in comparison with the above CMY data, is converted. At this time, since a look-up table to be used is the 1D-LUT, a processing quantity is never excessive. After the image data is generated, the sub controller 50 transmits a processing completion signal to the main controller 40 (S250) to wait to receive a driving signal transmission instruction to be transmitted from the main controller 40 (S260). In such a manner, processings can be dispersed by performing the processing on the K data in the sub controller 50. As described above, since the main controller 40 and the sub controller 50 can perform processings independently, the dispersed processings can be concurrently executed. In particular, the half-tone processing is required to be performed on each pixel, and the half-tone processings of the K data and the CMY data of which pixel numbers are different from each other cannot be performed collectively. The pixel numbers of the K data and the CMY data are different from each other because the resolutions thereof are different. However, these processings are dispersed to be concurrently executed, thereby improving the processing efficiency. Note that, although a compression processing and a transmission processing of the K data are required in order to disperse the processings, data transmission time can be made shorter by smoothly performing the compression processing as described above. Further, the compression processing and the transmission processing take relatively short time in comparison with the half-tone processing which is a processing performed on each pixel. Therefore, time required for each processing may not cause a large problem.

The main controller 40 which has received a processing completion signal in S180 transmits a driving signal transmission instruction to the sub controller 50 (S185). Thereafter, the main controller 40 transmits driving signals of the nozzles 32C, 32M, 32Y for one pass to the printing head 25 (S190). To be more specific, a driving signal generated from the CMY data for one pass is transmitted to each of the driving circuits 36C1 to 36Y2 of the printing head 25 through each of the transmission cables 44a to 44f. On the other hand, the sub controller 50 which has received the driving signal transmission instruction in S260 transmits a driving signal of the nozzles 32K for one pass to the printing head 25 (S270). To be more specific, a driving signal generated from the K data for one pass is transmitted to each of the driving circuits 36K11 to 36K22 of the printing head 25 through each of the cables 54a to 54d. After the CMYK data for one pass is transmitted to the printing head 25, the main controller 40 controls each motor to execute a printing process for one pass (S195). These processings are repeatedly executed until there is no data for the next pass.

Next, correspondences between components in the embodiment and components in the invention will be made to be obvious. The main controller 40 in the embodiment corresponds to a “first processing device”, the sub controller 50 corresponds to a “second processing device”, and the printing head 25 corresponds to a “printing head”.

According to the ink jet printer 10 in the embodiment as described in detail above, the main controller 40 and the sub controller 50 are connected through the USB interfaces 42, 52. At the main controller 40 side, a black character region is extracted from RGB data of which resolution corresponds to K (600 dpi) so as to be taken out as K data and the K data is transmitted to the sub controller 50. Further, the resolution of remaining RGB data is converted to a resolution in correspondence to CMY (300 dpi) and the RGB data after the resolution conversion is converted to CMY data by referring to the 3D-LUT. Then, the converted CMY data is binarized by the half-tone processing to generate image data for CMY. At the sub controller 50 side, the received K data is binarized by the half-tone processing to generate image data for K in parallel with the processings in the main controller 40. Therefore, printing quality of the black character can be more improved while a printing speed can be faster. In addition, the sub controller 50 performs the color conversion processing on the received K data to produced K data which is appropriate for printing by using the 1D-LUT. Therefore, a processing quantity can be suppressed from being excessive while printing quality of the black character can be more improved. Further, since the K data is effectively compressed by the run-length encoding, which is a lossless compression, and transmitted, data transmission time can be made shorter without deteriorating image quality. Therefore, an entire processing speed can be suppressed from being reduced due to the communication time.

It is needless to say that the invention is not limited to the above embodiment and the invention can be realized in various aspects as long as the aspects are within the technical scope of the invention.

In the above embodiment, the nozzle density of the nozzles for K in the printing head 25 is formed to be high and the nozzle density of the nozzles for CMY is formed to be low. However, the invention is not limited thereto and the nozzle density of the nozzles for CMY may be formed to be high and the nozzle density of the nozzles for K may be formed to be low. In this case, it is sufficient that image data input from the memory card MC is stored in the SDRAM 45 as RGB data of which resolution corresponds to dots of CMY. Further, it is sufficient that after K data extracted in the printing process is subjected to a conversion processing to a resolution of 300 dpi, the K data is transmitted to the sub controller 50, or the sub controller 50 includes a resolution conversion processing unit and the resolution of the received K data is converted to the resolution of 300 dpi. Each of the nozzle groups 30C, 30M, 30Y, 30K1, 30K2 is configured to include two nozzle rows in the embodiment. However, the invention is not limited thereto and one row or three or more rows may be included in each of the nozzle groups 30C, 30M, 30Y, 30K1, 30K2.

In the above embodiment, the K data is compressed by the run-length encoding. However, the compression method is not limited to the run-length encoding and the K data may be compressed by other lossless compression methods such as Huffman coding. Further, the method is not limited to the lossless compression methods and, lossy compression methods may be used. Moreover, such compression processing may not be performed and the extracted K data may be transmitted as it is. However, in order to make the data transmission time shorter, the compression processing is preferably performed as in the embodiment.

In the above embodiment, judgment whether the target pixel in the RGB data is a pixel constituting a black character is performed as follows. That is, it is judged whether each tone value of the target pixel is equal to or greater than a predetermined threshold value and R=G=B is satisfied. If each tone value of the target pixel is equal to or greater than the predetermined threshold value and R=G=B is satisfied, pattern matching is performed by using 3×3 pixels of which center pixel is the target pixel. However, the judgment method is not limited thereto and the judgment may be performed by any other methods. For example, the processings of the pattern matching may be eliminated.

In the above embodiment, the image data stored in the memory card MC is input. However, the invention is not limited thereto, and image data transmitted from a personal computer may be input. As image data transmitted from a personal computer, CMYK data may be transmitted. In this case, color conversion processings in S150 and S220 may not be performed.

In the above embodiment, ink colors are set to four colors of cyan (C), magenta (M), yellow (Y) and black (K). However, the ink color is not limited to four and may be set to five or six colors including light cyan (LC), light magenta (LM) or the like, or to a plurality of colors which is seven or more.

In the above embodiment, each controller includes a USB interface. However, the invention is not limited thereto and each controller may include other standard interfaces such as the IEEE1394 interface.

In the above embodiment, the image processing apparatus is connected to the printing head 25 of the ink jet printer 20. However, the invention is not limited thereto and the image processing apparatus may be connected to a printing head which can discharge ink in an apparatus such as a facsimile machine.

What is claimed is:

1. An image processing apparatus which generates print data for driving a printing head having nozzle groups for color which are capable of discharging ink at a first resolution and nozzle groups for black which are capable of discharging ink at a second resolution which is higher than the first resolution comprising:
a first processing device which inputs image data; and
a second processing device which is communicably connected to the first processing device through a predetermined communication interface,
wherein the first processing device acquires a color image having the second resolution, extracts a black character region image from the acquired color image, transmits the extracted black character region image to the second processing device through the predetermined communication interface, and generates print data for driving the nozzle groups for color from a not-black character region image which has not been extracted from the acquired color image as the black character region image accompanied with a resolution conversion to the first resolution, and
the second processing device generates print data for driving the nozzle groups for black based on the black character region image transmitted from the first processing device.

2. The image processing apparatus according to claim 1,
wherein the first processing device acquires image data of an RGB color system having the second resolution as the color image, extracts the black character region image from the acquired image data of the RGB color system and transmits the black character region image to the second processing device as K data of a CMYK color system, converts the resolution of the remaining not-black character region image to the first resolution, converts the color of the image data after the resolution conversion to CMY data by using a three-dimensional look-up table, and generates print data for driving the nozzle groups for color by performing a binarization processing on the converted CMY data, and
the second processing device generates print data for driving the nozzle groups for black by performing a binarization processing on the K data received from the first processing device.

3. The image processing apparatus according to claim 2,
wherein the second processing device generates the print data by subjecting K data received from the first processing device to a color adjustment by using one-dimensional look-up table and binarizing the K data which has been subjected to the color adjustment.

4. The image processing apparatus according to claim 1,
wherein the first processing device compresses the extracted black character region image by using a predetermined compression processing and transmits the compressed image to the second processing device, and
the second processing device decompresses the received compressed image and generates the print data by using K data obtained by the decompression.

5. The image processing apparatus according to claim 4,
wherein the predetermined compression processing is a lossless compression processing.
